(19) United States
(12) Patent Application Publication
(10) Pub. No.: US 2022/0010781 A1
(43) Pub. Date: Jan. 13, 2022

(54) Windmill electrical power system and Torque Enhanced Transmission

(71) Applicant: Jerry Dewayne Washington, JR., Mobile, AL (US)

(72) Inventor: Jerry Dewayne Washington, JR., Mobile, AL (US)

(73) Assignee: Legacy IP, Duncanville, AL (US)

(21) Appl. No.: 16/988,604

(22) Filed: Sep. 7, 2020

(30) Foreign Application Priority Data
Jul. 9, 2020 (CA) 3086465

(51) Int. Cl. F03D 15/00

(52) U.S. Cl. CPC F03D 15/00

(57) ABSTRACT

A system for generating electrical power in a windmill using a Torque enhanced Transmission. The transmission includes, multiple speed increasers, multiple speed decreasers, and a plurality of flywheels, and clutch assemblies. to form one transmission, The speed increasers speed the flywheel assemblies to a much higher speed than the operating speed of the generator so kinetic energy is maximized before a gear reduction slows down the output shaft to the induction generators operating speed with enhanced torque. The Torque is continually variable while output speeds are designed to be relatively constant. The system allows for multiple input and output shafts and allows for multiple generators to be used in place of a larger single generator.

### BACKGROUND OF THE INVENTION

The present invention relates generally to systems and methods for generating power. Both electrical and mechanical power using a Torque Enhanced Transmission, The Transmission includes Multiple flywheels. Speed increasers, speed decreasers, and clutches. The Torque enhanced gearbox in U.S. Pat. No. 10,293,906 teaches a Torque enhanced gearbox that operates by increasing rpm and the exponential increase in the amount of kinetic energy as speed increases. For example, when speed doubles kinetic energy increased by a factor of four. The last stage of the Torque Enhanced Transmission uses a speed decreaser to reach the desired speed while increasing the torque. For example, a 3× reduction in speed produces a 3× increase in torque. What is needed are speed increasers after each flywheel and a perpendicular or parallel shaft at each speed stage allowing traditional gears to be replaced by lower cost speed increasers or decreasers as well as multiple ports to attach additional prime movers and multiple power output options. The transmission of the current invention can be applied to numerous applications as the RPM input range is greatly increased. For example, slow and intermittent input speeds are a major factor in the higher cost of many renewable energy sources. Wind, solar, geothermal, hydro are sources of energy that would benefit from the Torque enhanced transmission by reducing cost per kilowatt hour and add energy storage for improved grid peak load management. High speed applications like UPS power systems that require 50,000 rpm or more can use the Transmission to reach these speeds while producing AC and DC power in one system or using both AC, DC or any other fuel type the application calls for. Multiple speed stages are a useful improvement and described with the present invention. The torque enhanced transmission can be used to produce power from a wide range of range of prime movers. Torque Enhanced Transmission includes multiple flywheels, clutches, and multiple speed increasers replace a single large ratio speed increaser and gears can be used in place of each, The multiple stages having a perpendicular shaft attached to each speed stage comprise the Torque Enhanced Transmission. The Transmission. capable of achieving output speeds that are optimal for electrical and mechanical power while accepting prime mover input speeds, input torque and variable run times. The generator and grime mover can be smaller, therefore reducing cost of the system and the sum output of using several smaller sized generators offer sizing options and lower cost when compared to a windmill that uses one large generator. The system speeds up to store maximum kinetic energy and capture energy from a wide range of speeds, for a longer time, and with variable amounts of energy amounts. The energy is delivered at a rpm that lowers cost for the system. improves efficiency of the generator, captures more input power source while providing peak load power and energy storage for maximizing the grid demands for electricity or the mechanical power needed to move vehicles with high weight, For example, a vehicle can have a reduced size prime mover, but top end speeds are reduced. The Torque enhanced transmission is attached to the drive shaft to produce mechanical power and is engaged for peak loads. The prime mover can be a small electric motor and the gasoline engine is reduced by a significant size. An all-electric vehicle can have the same small motor in addition to its electric motor prime mover and it acts as a turbo charger for an electric car as electric motor torque is constant and excess torque goes to the torque Enhanced transmission then to mechanical or electrical power. The system can generate power from regenerative breaking as power flows back from the wheel to recharge the battery or to aid a fossil fuel engine therefore reducing size.

U.S. patent application Ser. No. 10/293,506 and International application number PCT/US203/035909 and having International publication number WO 2004/045040, teaches a torque enhanced gearbox and a method of generating power using a speed increaser, flywheel, clutch, and speed decreaser to bring the speed of the flywheel assembly to a speed above the operating speed of the generator then stepping down the output shaft with a speed decreaser. Renewable energy sources such as wind, solar, hydroelectric, geothermal, in general produce motion in low rpm ranges. Such energy sources are also more varied in amount of energy produced, time, and the force they have. Many generators are designed to operate at speeds that standard industry gas, or electric motors operate around. With the cost per kilowatt hour being a determining factor of today's alternative energy paths a cost-effective way to harness a wide range of input speeds is needed.

U.S. patent application Ser. No. 10/293,506 and International application number PCT/US203/035909 and having International publication number WO 2004/045040 teaches a gearbox that includes a single speed increaser and a single claim speed increaser can have a higher gear ratio that equals the sum of multiple speed increasers but limits features and benefits that multiple speed increasers provide. Some of the advantages adding the speed incresers in multitude include allowing for additional input output speed combinations, reduce cost by allowing less expensive speed increaser options as a pully belt driven variable speed pully transmission system.

What is needed is a Torque Enhanced Transmission with a wider range between input speeds output speeds that maximize the benefits of The Torque enhanced Transmission and allow the higher constant speed s that induction type generators require. Adding multiple speed stages in a flywheel transmission offers a cost reduction in gearing and generators. Efficiency is increased by the transmissions relatively constant output speed. Multiple speed increasers can accept lower rpms and achieve higher output speeds. While the obvious solution of an educated experienced person might be to simply use a larger ratio of the single speed increaser is an inferior and less effective system and transmission of power. The flywheels in the transmission become more that energy storage devices and act as a stress reduction in the system thus allowing more cost-effective speed increasers. With lower stress on the system lower cost gearing can be used while allowing the input speeds as well as output speeds have a wider range. Furthermore, the system allows the constant speed induction generator to be used and the inverter to be omitted from electrical generating systems.

The large gear ratios in conventional windmills cause many problems such as downtime and an overall reduction in return on investment for systems using them. The large gear ratios put heavy stress on windmill components and lead to higher cost of operation. Large multistage Planetary gearboxes do not provide energy storage, cost more, and are under high stress and do not attach to multiple generators or prime movers with the simplicity as the present invention. Inverters. synchronous generators add cost and unwanted fluctuations in the grid. Induction generators have a much smaller operating rpm range and the Torque enhanced transmission allows a solution to the induction generators small, relatively constant rpm, operating range. The relatively constant and multiple output speeds of the transmission allow power to be delivered at application specific speeds. The Torque Enhanced Transmission allows for the induction type generator to be used as well as its size to be reduced and the multiple speed stages allow for multiple types of generators of smaller size can be used where the sum of the multiple smaller generators or power applications equals the power output of one larger generator used in other electrical or mechanical power applications that use traditional gearboxes.

The torque enhanced transmission is a vast improvement over the Gearbox used in traditional windmills. The addition of speed increasers in several stages vs using one speed increaser with a lager gear ratio is a useful improvement as the flywheels in the torque enhanced Gearbox allow multiple stages of speed and gives a platform for the speed of the next thus reducing cost of the gearbox and stress on the system. Generator size can be reduced if the system to run for longer with lower output if the speeds can be designed for in a cost-effective way. For example wind turbine blades might operate at 36 rpm and a single speed increaser would not be able to be a simple and efficient cost effective component if its ratio were say 50 to 1 but a five to one ratio can be used to turn first said flywheel at 180 rpm and the next could increase to 900 rpm then 4500, then 22500 rpm and as many stages as needed. The large gear ratio of large conventional windmill gearboxes has been known to break down and are expensive. The Torque Enhanced Transmission steps up the speed while not under load and the energy storage device aspect allows for multiple points to increase speed while maintaining its primary job as an energy storage device.

Each speed stage having a perpendicular and or a parallel shaft that allows for power to be delivered to multiple smaller generators, or to mechanical power applications. The method and design described here are not simply a different way to accomplish what a single larger gear ratio speed increaser would accomplish. reduced. Adding multi stages and multiple speed increasers allow a greatly improved system. The higher speeds needed to use the induction type generator, provide backup power, peak load protection requires multiple speed increasers to maximize the benefits in generating power as well as lowering cost, and allowing for multiple prime movers and a variety of generators.

Permanent magnet generators can benefit from the Torque enhanced transmission. The transmission would allow for a much smaller diameter and reduce permanent magnets needed small PMG and the speed increasers would work in reverse during system shutdown by draining the power from the system after the induction type generator falls below its operating range. The PMG could be used to charge the battery system that supplies power to a small electric motor used to maintain the systems speed. During times of no wind or power input or if the energy would be better used later. The torque enhanced Transmission is a mechanical battery when a motor and generator are attached. A battery that produces and outputs AC power and works as hybrid type battery when used with DC battery types. Magnetic bearings are used, and the Torque enhanced Transmission is enclosed in a vacuum.

The complete elimination of the gearbox in permanent magnet direct drive systems have disadvantages the Torque enhanced gearbox can improve or eliminate. For example large diameters are needed in the generator to make up for very slow input speeds, In direct drive systems the radius of the generator is made larger because of the low input speeds and these generator types use rare earth magnets therefore increasing cost of the system. The inverter is still required, and the size of the components cannot be reduced and therefore cost more. The large diameter of the stator could be retrofitted and used as a flywheel in the Torque enhanced transmission would allow a more compact hub even with a small gear ratio while using a PMG and an induction generator in the same system. While the gearbox is eliminated the direct drive permanent magnet generator, the extra-large diameter of the generator, rare permanent magnets, high cost inverter, and lack of energy storage makes the cost of a torque enhanced transmission an economic value. The torque enhanced transmission would be useful with these generator types, by reducing the diameter where the magnets are needed, Using the transmission allows both induction and PMG to be used in one system. The Torque enhanced transmission allowing multiple generators of different type be used in one system while reducing the stress and cost of the system.

The range of acceptable input/output speeds and the other benefits described here would improve other power generating systems. Adding Torque enhanced Transmission will allow generator prime mover combinations to previously cost prohibitive applications. Ocean wave energy can be extracted and stored in the system to produce mechanical and or electrical energy for a marine vessel. The Torque Enhanced Transmission is a useful invention as energy can be stored, generator size reduced or divided into smaller generators of different types all while increasing efficiency of the generator and capturing more energy from more difficult forms of energy. Improving peak loads in the grid and improves the energy storage issues some renewable energy sources have. Using multiple speed increasers allows multiple speed stages that are used to maximize to finale stage speed and kinetic energy storage and allows a perpendicular or parallel shaft to be attached at each speed stage allows options to the number and type of prime movers and generators and or mechanical power outputs. The flywheels act as energy storage devices, allow a wide range in acceptable speeds as well as reduce system stress. The added speed increasers, perpendicular or parallel shafts at each stage in the Transmission.

Torque enhanced transmission allows low rpm input applications to reach the high speeds needed in a cost effective and efficient way and adding speed increasers in smaller but multiple gear ratios is the only way to achieve this. The use of multiple speed increasers is only beneficial because of the flywheels and the need to maximize speed with low stress on the system. The obvious solution would be to simple increase to gear ratio of the single speed increaser and the benefits described in the present invention would not be practical in that scenario. Simply increasing the gear ratio of the current speed increaser causes most stress on the gears, limits flywheel design option, and limits the possible rpm input output combinations. Furthermore, higher rpm Speeds can be achieved with multiple speed increasers without the challenges associated with large ratio gearboxes.

### SUMMARY OF THE INVENTION

Accordingly, one object of the present invention is to provide a power generation system that is less expensive while expanding the range of acceptable input speeds and input methods while offering many generator size and type ranges thereby increasing the number of applications it can be applied to. Cost are reduced with a smaller generator and the same output can be achieved with smaller generators by increasing run time. Furthermore, multiple small generators can be used with the output being the same as a single large generator. The prime mover can be sized larger or smaller with no needed adjustment to the size of other components of the system.

These and other objects, which will become clear to someone practicing the present invention, The system includes a renewable energy source, a torque enhanced transmission or torque-enhanced gearbox, including multiple flywheels of different sizes and operating at different speeds in different stages with magnetic bearings for a less stressful work load, and with reduced size induction generator, while providing increased production and providing peak load for the grid. The multistage with speed increasers between each stage is a non-obvious and adding multiple different speed increasers at different stages has multiple benefits when compared to simple increasing the gear ratio of a single speed increaser For example the shafts connected parallel or perpendicular to the main shaft allow for a more application specify system design.

Thus, although there have been described embodiments of the present invention of a new and useful Torque enhanced Transmission for generating power. It is not intended that such references be construed as limitations upon the scope of this invention

### BRIEF DESCRIPTION OF THE DRAWINGS

FIG. 1 is one embodiment of the present invention using the Torque Enhanced Transmission in a windmill.

FIG. 2 a picture of the prior art.

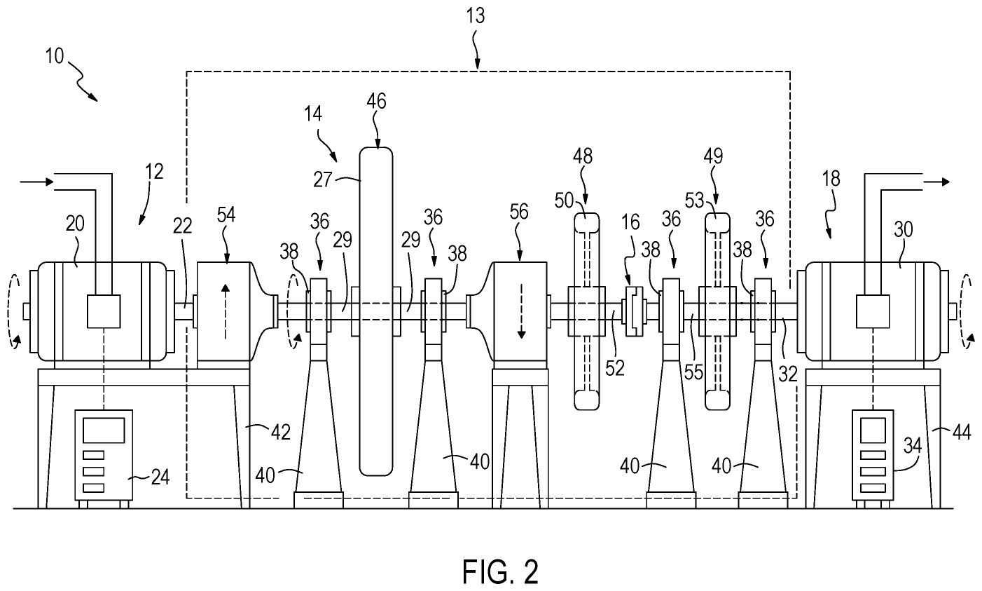

FIG. 3 shows prior art

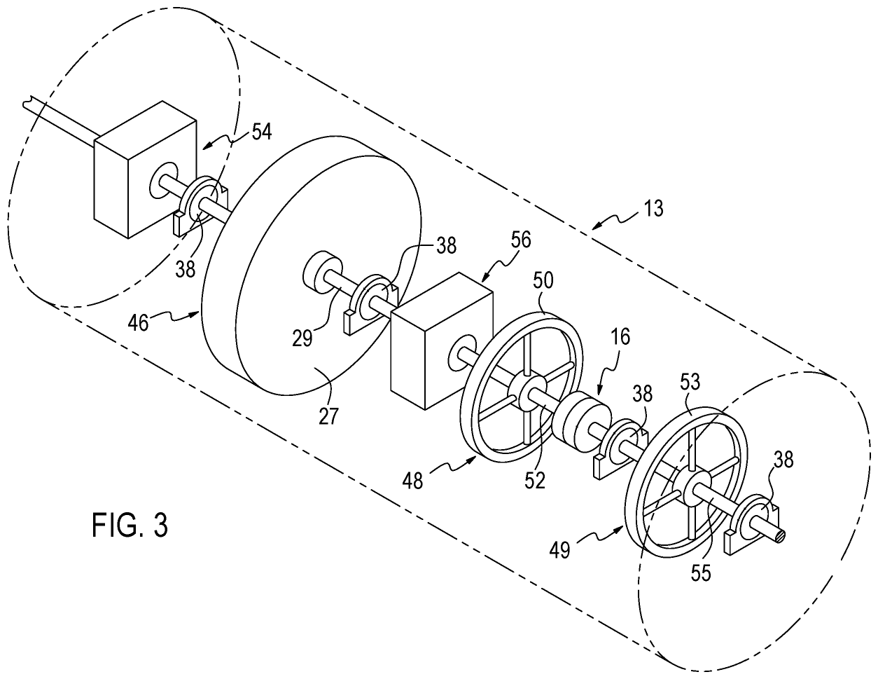

FIG. 4 Windmill with multiple generators

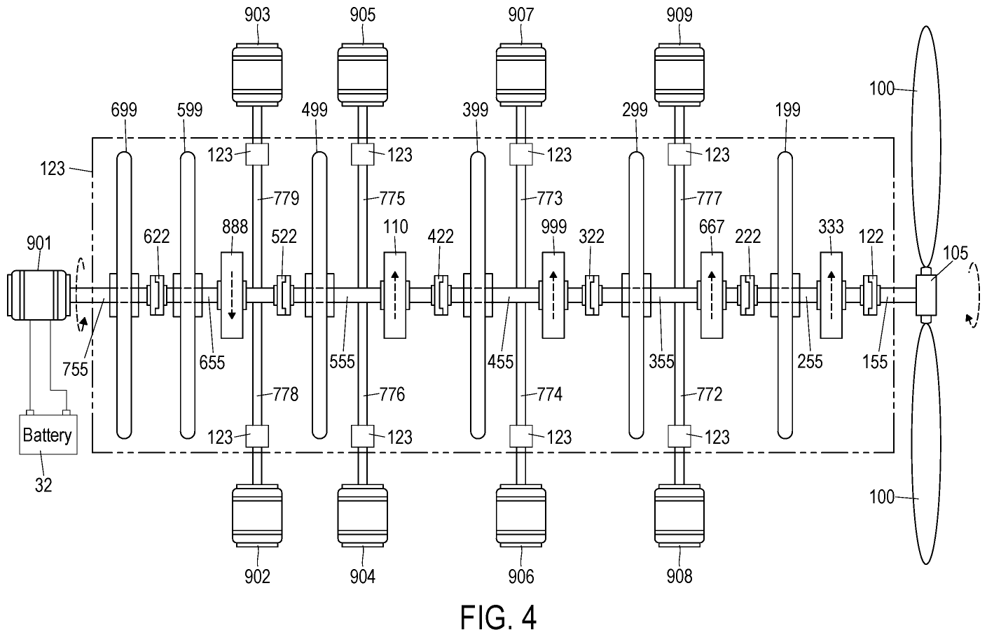

### DESCRIPTION OF THE PREFERRED EMBODIMENTS

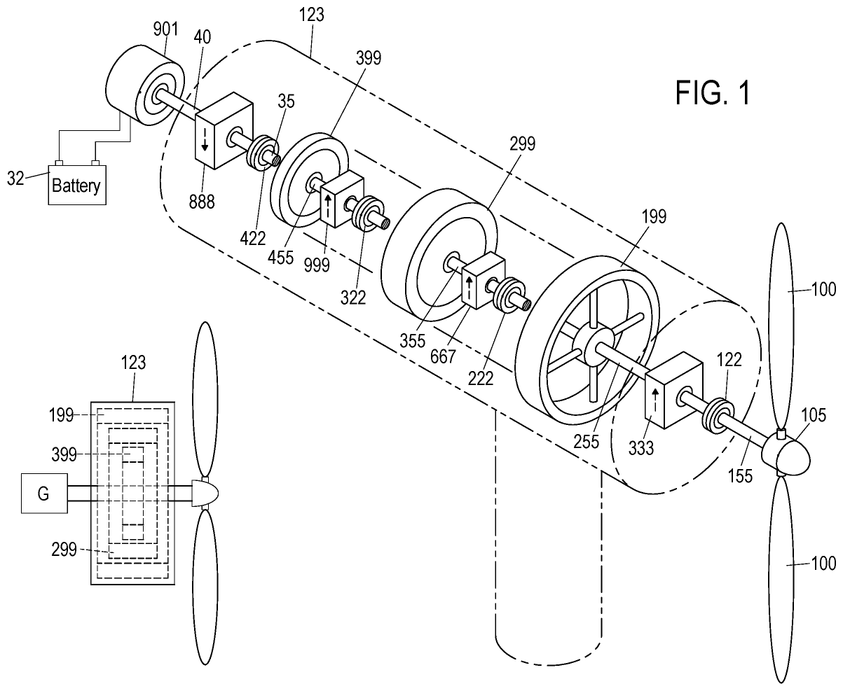

Referring to FIG. 1, The Torque Enhanced Transmission 123 of the present invention includes a first speed increaser 333 a first large diameter flywheel 199 a first perpendicular shaft 777 a clutch 111 a second speed increaser 667 a second flywheel 299, with a smaller diameter so it can fit inside the first flywheel a second perpendicular shaft 772 a second clutch 222 a third speed increaser 999 a third flywheel 399 coupled to a third perpendicular shaft 773 and also to the main shaft 5 and to a speed decreasing devise 333 and a second generator assembly is connected to the output shaft of The Torque Enhanced Transmission 123 The size and mass of the flywheels, 199,299.399. In one version of this embodiment, the first flywheel 199 is a spoked flywheel with a weighted outer perimeter 2200 kg and the second 299 fits inside the first and the third flywheel fits inside the second and are enclosed in a vacuum. The Wind turbine blades are able to deliver more energy to the transmission 123 as all speeds deliver energy to the Torque Enhanced Transmission and interior speeds achieved by the transmissions energy storage devices are capable of much greater speeds than required by the generators but the speed decreaser delivers a desired RPM, the gearing down increases torque and provides a relatively constant speed operation for the induction generator. The generator connected to the main shaft 5 is an induction generator 18 and the generator connected to any perpendicular shaft can be any type. If the generator shaft falls below the speed of the induction generator the generator disengages until the system speed increase and the generator connected to the perpendicular shaft 773 remains engaged. The transmission operates with varied speed in different stages in order to operate the constant speed induction generator with as little variation in rpm range thus reducing stress on the system and increasing efficiency of the system a motor is connected to a perpendicular shaft 777 Connected to a battery bank 32

What is claimed is:

1. A Wind turbine electrical system comprising wind turbine blades and a torque-enhanced Transmission. A torque-enhanced transmission comprising: An input shafts
a first speed increaser.
A clutch attached to the speed increaser
a first flywheel assembly coupled to clutch
A perpendicular shaft coupled to the first flywheel output shaft
A second output shaft connected to first flywheel output shaft
A second clutch
a second speed increaser coupled to the second clutch
a second flywheel assembly coupled to the second speed increaser
A perpendicular shaft coupled to the output shaft of the second flywheel A second output shaft connected to output shaft of the second flywheel.
and a speed decreaser between the second flywheel output shaft and the output shaft of the Torque Enhanced Transmission.

2. The Torque Enhanced Transmission of claim 1,
further including a third clutch coupled to
a third speed increaser coupled a third flywheel assembly
A perpendicular shaft coupled to the output shaft of third flywheel
A third output shaft connected to output shaft of third flywheel connected between second flywheel and speed decreaser of claim 1.

3. The Torque Enhanced Transmission of claim 2, further including a fourth clutch
a fourth speed increaser a fourth flywheel assembly.
A perpendicular shaft coupled to the fourth flywheels output shaft
a speed decreaser coupled between fourth flywheel output shaft and the output shaft of the Torque enhanced Transmission.

4. The Torque Enhanced Transmission of claim 3, further including a fifth clutch connected to a fifth speed increaser coupled to a fifth flywheel assembly. A perpendicular shaft coupled to the fifth flywheel
a speed decreaser coupled between fifth flywheels output shaft and the output shaft of the Torque enhanced Transmission.

5. The Torque Enhanced Transmission of claim 4,
further including a sixth clutch connected to a sixth speed increaser coupled a sixth flywheel assembly having a
A perpendicular shaft coupled to the output shaft of sixth flywheel
A right angel output shaft connected to output shaft of sixth flywheel a speed decreaser coupled to the output shaft of the sixth flywheel and output shaft of the Torque enhanced Transmission

6. A torque-enhanced Transmission of claim 5 further including:
A seventh clutch connected to output shaft of seventh flywheel a seventh speed increaser connected to seventh clutch
a seventh flywheel assembly connected to seventh speed increaser
A perpendicular shaft coupled to the output of seventh flywheel, a speed decreaser coupled to the seventh flywheel assembly output shaft; and the output shaft of the Torque enhanced Transmission

7. A torque-enhanced Transmission of claim 6 further including: An eighth clutch connected to output shaft of eighth flywheel
an eighth speed increaser connected to eighth clutch
an eighth flywheel assembly connected to eighth speed increaser A perpendicular shaft coupled to the output of eighth flywheel
a speed decreaser coupled to the eighth flywheel assembly output shaft and the output shaft of the Torque enhanced Transmission.

8. The Transmission of claim 7, wherein the Torque Enhanced Transmission has multiple speed stages. and having a perpendicular or parallel shaft coupled to each speed stage and a second Torque enhanced transmission of claim 1 attached to each parallel or perpendicular shaft.

9. The Transmission of claim 1-8 wherein the speed increaser and the speed decreaser are elliptical gears, magnetic, planetary, toothed, worm, the system of claim 1-8, wherein the speed increaser is a type of pulley based CVT (Continuously Variable Transmission) automatic transmissions-fixed ratio gears or any combination of these types.

10. The Torque enhanced transmission of claim 1-8 being used in systems comprising wind turbines, ship propulsion, actuation systems, machinery motors crushers, electric vehicle systems, traction systems, drilling motors, oilfield equipment, water pumps, hydraulic variators, air turbines, jet turbines, air compressors, hydroelectric water turbines, electric generator systems, them al engines, residential HVAC systems, air compressors, back up power systems, portable and home generators, electric car charging stations, electric car transmissions, geothermal, power generation, wave generating power systems, submarine and marine vessel propulsion, trains, electromagnetic propulsion, nuclear power, elevators, lifts, electrical inverters, electrical transformers, submarine, fossil fuel engine crank shafts, and used as a mechanical battery.

11. The Torque enhanced transmission of claim 1-8 further comprising a controller for controlling energy flow in and through the Torque Enhanced Transmission, magnetic bearings, and being enclosed in a vacuum.

12. A method for generating power using the Torque enhanced transmission system of claims 1-8 where that speeds up the output shaft with multiple speed increasers, having at least one at each speed stage, to achieve a speed much higher than the application requires and while kinetic energy is exponentially increased with speed of the flywheel, and using a speed decreaser to slow down the output shaft to a more usable speed and increasing output torque, through down gearing.

13. The Torque enhanced transmission described in claims 1-8 where the term speed increaser is interchangeable with speed decreaser gears, or multi speed transmission.

14. The Torque enhanced Transmission from claim 1-8 wherein the flywheels are connected to a mechanical coupling member that combine multiple flywheels together The Transmission of claim 1-8 claims any clutch can separate any flywheel from, the any part of the Torque enhanced Transmission or anything connected to the input or output shafts, such that each component of the transmission can rotate independently from all other components.

15. A motor and or generator system comprising the Torque enhanced Transmission of claim 1-8 having a varied number of generators and or motors being induction type and connected at different output shafts of the transmission, to allow replacement of a single large generator, and where each motor is different in the number of poles and the torque enhanced transmission is a variable speed AC motor and or generator.

16. The Torque Enhanced. Transmission of claim 1-8 having clutches of engagement type, or frictional engagement type, magnetic clutch assemblies or a combination of multiple types.

17. An electrical generation system in a windmill, The system of generating electricity in Windmills consist of the Torque Enhanced Transmission in all claims wherein the windmill blades drive the Torque Enhanced Transmission to operate a constant speed induction generator. The system of generating electricity in Windmills in all claims wherein the windmill blades drive the Torque Enhanced Transmission and an electric motor keeps the speed of the transmission at a set idle speed and the electric motor draws power from the transmission.

18. Where the Torque enhanced Transmission of claim 1 is fit inside a rotating object such as a magnetic bearing assembly, wheel, crankshaft, a driveshaft for a motorized vehicle, PTO shaft, and having multiple rotating sections encased in the rotating object where the torque enhanced transmission is used to rotate the rotating object and the object rotates the transmission.

19. Where the Torque enhanced Transmission claims 1-8 beings used in applications having characteristics requiring variable torque and requiring high speeds at constant rpm high torque and low speed input speeds. enhanced variable torque, constant low speed output. low rpm inputs and, requiring a constant high-speed output. Where the Torque enhance Transmission has a continuously variable gear ratios internally a relatively constant output speed and being a continuously variable torque transmission.

20. The Torque enhanced Transmission from claim 1-8 Where the rotors from all components of the torque enhanced transmission use oversized rotors, shafts and magnetic bearing, the motor rotors. and the generator rotors are oversized and act as kinetic energy storage devices
